(19) United States
(12) Patent Application Publication
(10) Pub. No.: US 2026/0242677 A1
(43) Pub. Date: Aug. 20, 2026

(54) APPARATUS FOR PRODUCING SUSTAINABLE AVIATION FUELS USING SYNTHESIS GAS FUEL CELLS

(71) Applicant: Avioxx Limited, London (GB)

(72) Inventor: Michael David Hancock, Kelsall, Tarporley (GB)

(21) Appl. No.: 19/159,691

(22) PCT Filed: Mar. 13, 2024
(86) PCT No.: PCT/GB2024/050684

§ 371 Date: Aug. 26, 2025

(30) Foreign Application Priority Data
Mar. 15, 2023 (GB) 2303771.6

(51) Int. Cl. C10G 65/12; B01D 53/26; B01J 8/04; B01J 8/06; C01B 32/40; C10G 2/00; C10J 3/84; C10K 3/02; H01M 8/04014; H01M 8/0612

(52) U.S. Cl. CPC C10G 65/12; B01D 53/265; B01J 8/0492; B01J 8/065; C01B 32/40; C10G 2/341; C10J 3/84; C10K 3/026; H01M 8/04014; H01M 8/0643; B01D 2257/80; C10G 2300/1022; C10G 2400/08; C10J 2300/1646; C10J 2300/1659; C10J 2300/1684

(57) ABSTRACT

An apparatus, system or process for the manufacture of hydrocarbons suitable for use as aviation fuels which qualify as sustainable, based on the use of the apparatus described in patent GB2431511 Electricity generation by synthesis gas fuel cells. The apparatus uses hydrocarbons such as waste materials to make electrolytic hydrogen and carbon oxides which are further processed using reactors which may include those commonly known as Fischer-Tropsch.

### FIELD OF THE INVENTION

This disclosure relates to a manufacturing system for the production of liquid fuels which may qualify as Sustainable Aviation Fuels (SAFs), and which uses hydrocarbon materials which may include mixtures containing biomass, municipal solid wastes or waste oils as a feedstock.

### BACKGROUND OF THE INVENTION

A commonly known process for making such fuels uses carbon dioxide and hydrogen, via a series of chemical reactions, including those known as “Fischer-Tropsch”. This process creates mixtures of long-chain paraffinic molecules similar to those found in fossil-derived fuels currently used extensively in aviation to power passenger jet aircraft. The benefit of these synthesised fuels is the potential to decarbonise air travel without the need for major changes to airframe platforms.

The qualification of aviation fuels as “sustainable” is in the gift of the ASTM (American Society for the Testing of Materials). A key condition is the sustainable way that the hydrogen is provided and the energy used in the process is derived. Hydrogen produced from the electrolysis of water using electricity generated by, for example, wind turbines or other “renewable” techniques, would qualify.

### SUMMARY

The present invention provides an apparatus for producing hydrocarbon fuels comprising a first set of equipment and a second set of equipment, as set forth in claim 1.

Preferred features are set forth in the dependent claims.

This proposal is based on the use of a patented process as described in GB2431511. This uses hydrocarbon materials to generate power. As byproducts of such power generation, electrolytic hydrogen and a highly-concentrated stream of carbon dioxide are produced. This is done by using a configuration of apparatus including a gasifier, a solid oxide fuel cell stack and a water electrolyser. Whereas the main purpose of this set of equipment is to generate power, this set of equipment does provide the feedstocks (carbon oxides and hydrogen) which are suitable for the production of liquid fuels consisting of the long chain paraffinic compounds and which are potentially acceptable as Sustainable Aviation Fuels (SAFs).

This proposal relates to a process, apparatus or system in which the embodiment described in GB2431511 is integrated with the systems which produce the paraffinic compounds for use in Sustainable Aviation Fuels. In so doing any surplus energy generated in some parts may be usefully consumed in others. Similarly wastes and effluents can be recycled internally to improve the overall yield.

### BRIEF DESCRIPTION OF THE DRAWINGS

FIG. 1 shows a first set of equipment, used to generate power and also to generate hydrogen and carbon dioxide; and

FIG. 2 shows a second set of equipment, which receives the hydrogen and carbon dioxide from the first set of equipment and produces sustainable aviation fuel.

### DETAILED DESCRIPTION OF THE PREFERRED EMBODIMENTS

The preferred embodiment relates to a power generation system, which uses hydrocarbon fuels, including mixtures containing biomass or waste oils.

Fuel Cells can be used to produce electricity using a number of materials as fuels. Those of primary importance use gaseous hydrogen and air, which combine to make water. Fuel cells using a mixture of hydrogen and carbon monoxide (often called synthesis gas or “syngas”) have also been shown to produce electricity together with water and carbon dioxide. Syngas is produced when hydrocarbons are reacted with air and steam in a reformer, or when combined with an oxygen rich gas in a process known as “gasification” or “partial oxidation”. The use of oxygen instead of air means that carbon dioxide can be more easily captured since it is not mixed with nitrogen and the other minor constituents of air. This proposal relates to an integrated process in which a portion of the electricity produced in the fuel cell unit is then used in the other process steps, notably but not exclusively the electrolytic production of oxygen which is then used for gasification.

Similar integrated processes have been patented such as US2005123472, in which hydrogen, used to power a fuel cell, is produced from syngas, made by steam reforming in a compact catalytic reactor. Prior to the reactor, an oxygen and fuel mixture is first subjected to plasma treatment in a dielectric barrier plasma reactor. This oxygen is produced by electrolysis using part of the fuel cell power output. The system now proposed simplifies the process by eliminating the gas separation stages needed to produce pure hydrogen, and by substituting a fuel cell system, which works on syngas.

Because the process generates its own oxygen supply to the gasification stage, the need for an air separation unit is avoided, and the apparatus can be more easily assembled, transported and operated in a remote location. Once running, the system needs only the supply of a hydrocarbon fuel, water and air to sustain operation. Examples of such remote locations are an offshore oilfield and an on-shore coalfield, where the apparatus could be connected to a means of disposing of the carbon dioxide by injecting it into porous rock formations. The CO2 may be used to enhance oil recovery.

Fixed installations of the apparatus could be used with Underground Coal Gasification to produce electricity on a large scale, and permit disposal of carbon dioxide in coal deposits.

The process should run on a range of fuels like coal or waste hydrocarbons such as lubricating oils as fuels. Additional process steps need to be incorporated, for the pre-treatment of the fuel, and removal of materials in the syngas, which could harm the fuel cells.

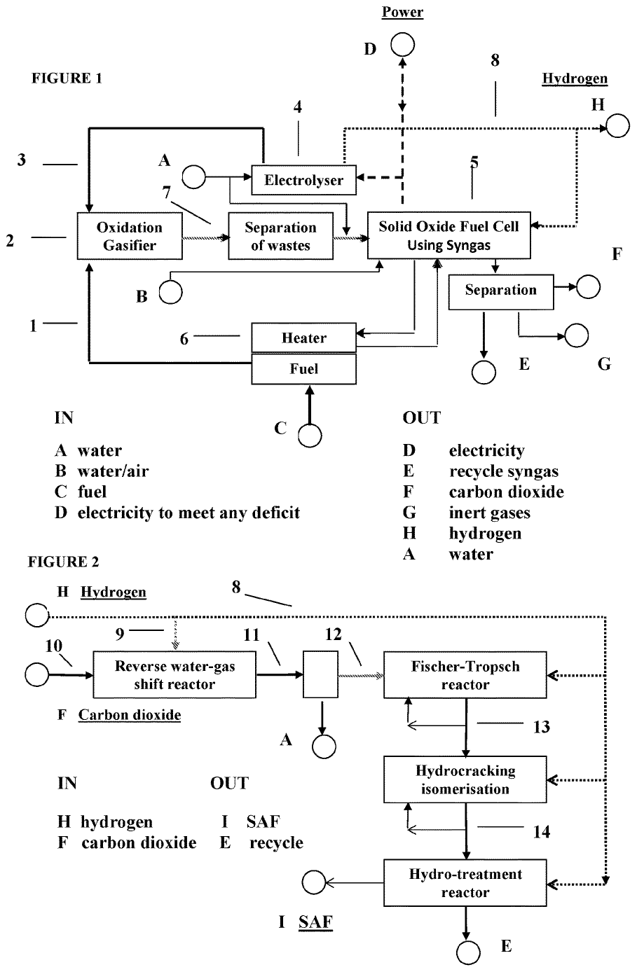

FIG. 1 shows a schematic flow-scheme of an apparatus or process proposed. Here the hydrocarbon fuel (C), which can be any oil or waste oil or coal or gaseous hydrocarbon fuel is heated in a heat exchanger (6). This exchanger transfers heat generated in the solid oxide fuel cell (5), or in the reactor, to the fuel.

The heated fuel is then conveyed to a reactor vessel or gasifier (2) where it reacts with an oxygen rich gas stream (3).

This gas stream, (3) contains oxygen which is preferably prepared in an electrolytic cell or stack of cells (4), which is in turn powered by the electrical output from the fuel cell (5).

The oxidation products emerging from the gasifier (2) consist mainly of carbon monoxide and hydrogen, as well as ash and un-reacted or partially reacted solids, tars, waxes and numerous gases and liquids. They then pass through a purification stage (7) wherein solid particles entrained in the gas are separated out, followed by hydrocarbon liquids and finally unwanted gases primarily sulphur containing compounds and others which could damage or adversely affect the performance of the fuel cell or other equipment downstream. The purification stage (7) also includes heat exchangers to bring the temperature to the preferred level for the operation of the fuel cell and to recover waste heat.

The purified syngas passes then to a solid oxide fuel cell which is also supplied with water or steam, and air or oxygen where electricity is generated together with water and carbon dioxide. Remaining gases such as un-reacted carbon monoxide, hydrogen and inert gases are separated. Carbon monoxide and hydrogen (E) may be returned to the gas stream at a point before the fuel cell.

The electricity generated in the fuel cell (5) is exported to a converter to make it into a usable form. Part of the production is fed to an electrolytic cell or stack (4) which produces hydrogen, (8) and oxygen (3). The oxygen (3) supplies the gasifier (2) and the hydrogen, (8) is fed to the fuel cell (5) to enhance its performance, or is channelled to a storage, usage or despatch point.

The attached graphical representation shows a schematic flow-scheme of an apparatus or process proposed. It includes two parts, firstly the embodiment described in GB2431511 (FIG. 1) and secondly the process for manufacturing the higher paraffins which are the major components of the SAF (FIG. 2). The hydrocarbon fuel (C), which can be any oil or waste or coal or gaseous hydrocarbon fuel or mixture of wastes such as Municipal Solid Waste, is conditioned (6) and fed to the oxidation gasifier (2) where it reacts in an oxygen-rich gas stream (3). The flow from the oxidation gasifier (7) is a synthesis gas comprising a mixture of carbon monoxide, hydrogen, water and carbon dioxide, plus hydrocarbons including various tars and residues. This stream is conditioned and unwanted components such as tars, residues and long-chain hydrocarbons are removed. This is useful to prevent poisoning or contamination of the fuel cell stack (5), the anode of which it is fed into. Steam may be added to this stream in order to promote the formation of hydrogen either internally within the fuel cell stack, or alternatively in a preliminary reactor. Air is supplied to the cathode side of the fuel cell stack. The electricity generated in the fuel cell stack is supplied to a water electrolyser (4) which produces hydrogen (8) and oxygen (3). A concentrated stream of carbon dioxide remains which may also contain water and unreacted syngas. This stream comprising mainly of carbon dioxide (10) is fed to a reactor where the reverse of the water-gas shift reaction takes place over a catalyst. The reaction is influenced by the equilibrium which exists between the partial pressures of the reactants and products. The supply of hydrogen to the reactor (9) ensures the balance shifts towards the production of a syngas of predominantly water, hydrogen and carbon monoxide (11). Water is removed in a dryer and the dried syngas enters the reactor containing tubes of catalyst in which the Fischer-Tropsch reaction takes place to form paraffinic molecules. Unreacted syngas is recycled and the paraffinic components (13) flow to a hydrocracking reactor which is supplied with more of the hydrogen produced in the electrolyser (8). Unreacted components are separated and recycled and the modified paraffins (14) flow into a hydro-treatment reactor to create the mix of components suitable for use as aviation fuel. The unreacted components are recycled.

1. An apparatus for producing hydrocarbon fuels comprising a first set of equipment and second set of equipment, as follows:
i) the first set of equipment which produces hydrogen, carbon dioxide and electricity, comprising:
a) a gasification vessel (2) into which is channelled carboniferous fuel (1) and oxygen (3) to form a synthesis gas containing carbon dioxide;
b) a fuel cell stack (5) which generates electricity using said synthesis gas as a fuel supplied to one pole and air and/or water (B) supplied to the other pole, and also generates a stream of gases including carbon dioxide and unreacted synthesis gas, and also water;
c) an electrolyser (4) which produces hydrogen (8) and oxygen (3) by the electrolysis of water (A) using at least a portion of the energy generated in said fuel cell stack (5), wherein at least a portion of the oxygen produced in the electrolyser is supplied to the gasification vessel, and wherein the produced hydrogen is provided as an output from the first set of equipment to an input of the second set of equipment; and
d) a means of separating un-reacted fuel cell off-gases carbon monoxide, carbon dioxide, hydrogen, and inert gases and also water, from each other, such that the carbon dioxide is provided as an output from the first set of equipment, to an input of the second set of equipment;
ii) the second set of equipment which receives the carbon dioxide and hydrogen produced and output from the first set of equipment and produces a mixture of hydrocarbons which corresponds to those found in fuels used in aviation for supplying the power to jet engines in aircraft, comprising:
a) a first reaction vessel (9) in which a reverse water-gas shift reaction takes place wherein the carbon dioxide output from the first set of equipment is reacted with the hydrogen which is also output from the first set of equipment to form carbon monoxide and water over a catalyst;
b) a second reaction vessel in which a Fischer-Tropsch reaction takes place between the carbon monoxide (12) output from the first reaction vessel and hydrogen output from the first set of equipment, to produce a plurality of paraffinic molecules;
c) a hydro-cracking vessel which receives the paraffinic molecules output from the second reaction vessel and in which the paraffinic molecules are reduced in length or changed in shape by reacting with hydrogen, which is output from the first set of equipment, using a hydrocracking process, over a catalyst, to produce a first plurality of modified paraffinic molecules; and
d) a hydro-treatment reactor which receives the first modified paraffinic molecules, and also receives hydrogen output from the first set of equipment, and further modifies the molecular structure of the first modified paraffinic molecules to produce a second plurality of modified paraffinic molecules which are further modified to more closely match those of a desired composition of fuels used in aviation to supply power to jet engines in aircraft.

2. The apparatus of claim 1, wherein any shortfall in energy requirement is met by supplying electricity from renewable sources (D) to the electrolyser (4).

3. The apparatus of claim 1, wherein a condenser is provided at the output of the first reaction vessel to remove water.

4. The apparatus of claim 1, wherein a gas cleaning apparatus (7) is provided at the output of the gasification vessel (2) in which at least one of solids, tars, residues and other impurities are removed from the synthesis gas output from the gasification vessel.

5. The apparatus of claim 1, wherein the second set of equipment further comprises a means of separating gases which exit the hydro-treatment reactor so that a sustainable aviation fuel is separated from unreacted components (E).

6. The apparatus of claim 5, wherein the unreacted components (E) are recycled into the gasification vessel (2) or another vessel.

7. The apparatus of claim 1, wherein the first set of equipment further comprises a heat exchanger (6) whereby the fuel (C) supplied to the fuel cell stack via the gasification vessel (2) is preheated using heat generated by the fuel cell stack (5).
